(19) United States
(12) Patent Application Publication
(10) Pub. No.: US 2026/0116163 A1
(43) Pub. Date: Apr. 30, 2026

(54) LIGHTWEIGHT SOLUTION FOR REMOVABLE ROOF PANELS

(71) Applicant: FCA US LLC, Auburn Hills, MI (US)

(72) Inventors: Ramachandra Bhat, Auburn Hills, MI (US); Abhishek Paul, Auburn Hills, MI (US); Nitin Sharma, Auburn Hills, MI (US)

(21) Appl. No.: 18/926,455

(22) Filed: Oct. 25, 2024

(51) Int. Cl. B60J 7/16; B32B 3/12; B32B 5/02; B32B 15/14; B32B 15/20; B32B 27/12; B32B 27/32

(52) U.S. Cl. CPC B60J 7/1642; B32B 3/12; B32B 5/02; B32B 15/14; B32B 15/20; B32B 27/12; B32B 27/32; B32B 2250/03; B32B 2250/40; B32B 2260/023; B32B 2260/046; B32B 2262/101; B32B 2307/304; B32B 2605/08

(57) ABSTRACT

A vehicle roof has a framework with longitudinal rails that extend between a front windshield area and a rear window, hatch or door area. The rails are spaced from one another to form an opening between the rails to receive one or more removable roof panels. The removable roof panels have an inner skin and an outer skin. A honeycomb core is sandwiched between the inner and outer skins. The honeycomb core is a non-porous material with strength and lightweight characteristics such as aluminum, polypropylene or the like.

### FIELD

The present disclosure relates to vehicles and, more particularly, vehicles that have removable roof panels.

### BACKGROUND

This section provides background information related to the present disclosure which is not necessarily prior art.

Removable roof panels are popular in vehicles to provide an open air experience. The panels are secured with the roof when they are not removed. When removed, they are generally stored in the trunk or the like. The removable panels need to be lightweight so that they are easily removed by the user and stored. Thus, it is desirable to have a lightweight roof panel that can be manipulated and moved by a single person.

The design and manufacture of vehicles approaches the need to enhance fuel economy, reduce greenhouse gas emissions and provide overall performance. To meet the CAFE (Corporate Average Fuel Economy) fuel economy standards and the U.S. Environmental Protection Agency (EPA) CO2 emissions, lightweighting is the powerful strategy to achieve it. The vehicle weight is directly proportional to the amount of energy needed to move the vehicle regardless of the type of energy system. The innovative design solutions and advancement in materials further enhance the impact of lightweighting and cost-effectiveness.

The open-air concept in vehicle design, while aesthetically pleasing and potentially offering other benefits, does indeed present challenges with traditional Sheet Molding Compound (SMC) panels. The increased weight can lead to ergonomic issues during manual handling and storage.

Overall, the synergy between a lightweight design and vertical integration strategies presents a formidable approach to achieving economic and environmental benefits in today's competitive market. Accordingly, it would be desirable to have a lightweight roof panel that overcame the deficiencies of the prior art.

### SUMMARY

This section provides a general summary of the disclosure, and is not a comprehensive disclosure of its full scope or all of its features.

According to the present disclosure, the present design provides a honeycomb core material, such as aluminum and polypropylene, that overcome moisture absorption issues. The proposed aluminum or polypropylene honeycomb roof design not only mitigates the risk of water infiltration but also contribute to the overall strength and longevity of the roof panels. The present disclosure enables selection of specific requirements such as mechanical properties, weight constraints, and environmental exposure, to ensure optimal performance and customer satisfaction. The present disclosure not only reduces the weight of the roof panel but also enhances structural efficiency, leading to economic and environmental benefits.

According to a first aspect of the disclosure, a vehicle roof comprises a framework with longitudinal rails that extend between a front windshield area and a rear window, hatch or door area. The rails are spaced from one another to form an opening between the rails to receive one or more movable roof panels. The removable roof panels include an outer skin and an inner skin. A honeycomb core is sandwiched between the inner and outer skin. The honeycomb core is formed from a non-porous material with strength and lightweight characteristics such as aluminum, polypropylene or the like. The inner skin and outer skin are of a glass fiber polypropylene composite. Securement members are coupled with the removable panel to retain the panel on the rails. The roof panel has an increased strength and longevity. The inner and outer skins are bonded to the honeycomb core. Additionally, insulation material may be positioned to the cells of the honeycomb core. The insulation material is integral with the inner or outer skins.

According to a second aspect of the disclosure, a vehicle including a roof comprises a framework with longitudinal rails that extend between a front windshield area and a rear window, hatch or door area. The rails are spaced on another forming an opening between the rails to receive one or more movable roof panels. The removable roof panels include an outer skin and an inner skin. A honeycomb core is sandwiched between the inner and outer skin. The honeycomb core is formed from a non-porous material with strength and lightweight characteristics such as aluminum, polypropylene or the like. The inner skin and outer skin are of glass fiber polypropylene composite. Securement members are coupled with the removable panel to retain the panel on the rails. The roof panel has an increased strength and longevity. The inner and outer skins are bonded to the honeycomb core. Additionally, insulation material may be positioned to the cells of the honeycomb core. The insulation material is integral with the inner or outer skins.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle roof with removable panels.

FIG. 2 is a partial cross-section view including a cutout of a roof panel in accordance with the disclosure.

FIG. 3 is a perspective schematic view of a honeycomb core.

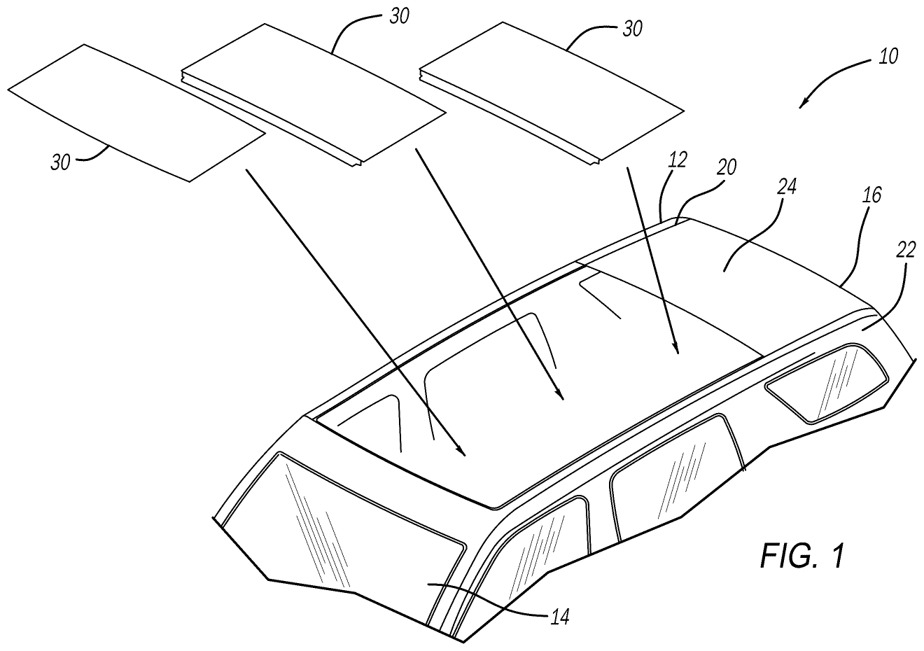

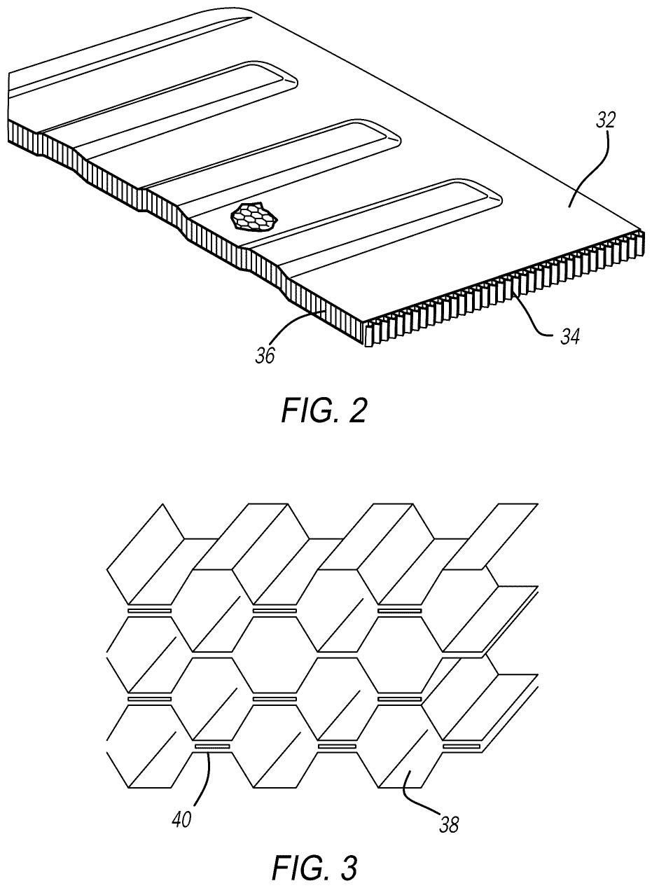

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes a roof 12 with a windshield area 14 and a rear window, hatch or door 16. A pair of rails 20, 22 extend from the windshield area 14 to the rear window, hatch or door 16 area. The rails 20, 22 are spaced from one another to define an opening 24 between the rails. The opening 24 receives one or more removable roof panels 30.

The roof panels 30 are positioned in the opening 24 in the roof 12 to provide a closed roof in the vehicle 10. The roof panels 30 are secured with the rails 20, 22 to secure the roof panels 30 in position on the roof 12. The roof panels 30 include a mechanism to secure with one another and may include a seal between the adjacent roof panels to enhance the sealing of the roof 12.

The roof panels 30 include an inner skin 32 and an outer skin 34. A honeycomb core 36 is sandwiched between the inner and outer skins 32, 34. The inner skin 34 and outer skin 32 are formed from a glass fiber polyurea composite. The inner and outer skins 32, 34 are bonded to the honeycomb core 36. The inner and outer skins 32, 34 may be poured or molded onto the honeycomb core 36 such that the honeycombs cells 38 are filled with the glass fiber composite providing insulation to the panel 30.

The honeycomb core 36 includes a plurality of cells 38 and nodes 40. The cells 38 generally have a hexagonal configuration with the nodes positioned between adjacent cells 38. The honeycomb core 36 generally has a desired length as well as height and thickness dimensions. Thus, the honeycomb core 36 is shaped like the roof panel 30 and is then covered with the inner and outer skins 32, 34.

The honeycomb core 36 is a non-porous material with lightweight characteristics. The non-porous material has desired strength to enhance the panels. The non-porous material may be aluminum, propylene or the like that is impervious to precipitation or liquid. Thus, if the moisture enters into the panel it will not be absorb nor will it degrade the sandwiched material. The cells 38 are positioned such that thickness extends between the inner and outer skins 32 and 34 to enable the cells 38 to be filled with the molded material if desirable when the inner and outer skins 32, 34 are molded with the honeycomb core. The nodes 40 provide connection between the adjoining cells 38. Also, the nodes 40 may be flat or have a space that likewise could be filled with the insulative molded material.

The strategic integration of the novel design and bionic inspired structure not only reduces the weight but also enhances the structural efficiency of the panel. This leads to economic and environmental benefits. Thus, the panel is lightweight and has a desirable strength characteristic. The panel can be modified to consider specific requirements of the application including mechanical properties, weight constraints and environmental exposure to enhance optimal performance and customer satisfaction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle roof comprising:
a framework with longitudinal rails that extend between a front windshield area and a rear window, hatch or door area;
the rails being spaced from one another forming an opening between the rails for receiving one or more removable roof panels;
the removable roof panel including an outer skin and an inner skin, a honeycomb core sandwiched between the inner and outer skins, the honeycomb core being a non-porous material with strength and lightweight characteristics such as aluminum, polypropylene or the like.

2. The vehicle roof of claim 1, wherein the inner and outer skins are of a glass fiber polyurethan composite.

3. The vehicle roof of claim 1, wherein securement members are coupled with the removable panel to secure the panel on the rails.

4. The vehicle roof of claim 1, wherein the roof panel has an increased strength and longevity.

5. The vehicle roof of claim 1, wherein the inner and outer skins are bonded to the honeycomb core.

6. The vehicle roof of claim 1, wherein insulation materials is positioned in cells of the honeycomb core.

7. The vehicle roof of claim 6, wherein the insulation material is integral with the inner or outer skin.

8. A vehicle including a roof comprising:
the roof including a framework with longitudinal rails that extend between a front windshield area and a rear window, hatch or door area;
the rails being spaced from one another forming an opening between the rails for receiving one or more removable roof panels;
the one or more removable roof panels including an outer skin and an inner skin, a honeycomb core sandwiched between the inner and outer skins, the honeycomb core being a non-porous material with strength and lightweight characteristics such as aluminum, polypropylene or the like.

9. The vehicle of claim 8, wherein the inner and outer skins are of a glass fiber polyurethane composite.

10. The vehicle of claim 8, wherein securement members are coupled with the removable panel to secure the panel on the rails.

11. The vehicle of claim 8, wherein the roof panel has an increased strength and longevity.

12. The vehicle of claim 8, wherein the inner and outer skins are bonded to the honeycomb core.

13. The vehicle of claim 8, wherein insulation materials is positioned in cells of the honeycomb core.

14. The vehicle of claim 8, wherein the insulation material is integral with the inner or outer skin.
